(19) United States
(12) Patent Application Publication
(10) Pub. No.: US 2025/0253679 A1
(43) Pub. Date: Aug. 7, 2025

(54) POWER SUPPLY SYSTEM

(71) Applicant: TOYOTA JIDOSHA KABUSHIKI KAISHA, Toyota-shi (JP)

(72) Inventors: Jinwoo KIM, Toyota-shi (JP); Fumiyoshi KURIBARA, Toyota-shi (JP)

(73) Assignee: TOYOTA JIDOSHA KABUSHIKI KAISHA, Toyota-shi (JP)

(21) Appl. No.: 18/939,570

(22) Filed: Nov. 7, 2024

(30) Foreign Application Priority Data
Feb. 7, 2024 (JP) 2024-016775

(51) Int. Cl. H02J 7/00; H02J 7/14

(52) U.S. Cl. CPC H02J 7/0019; H02J 7/0024; H02J 7/007186; H02J 7/1423; H02J 2207/20

(57) ABSTRACT

In a power supply system including a first battery and a second battery that can be charged and discharged by parallel connection using a three-phase coil of a series connection, an inverter, and a motor, when the open circuit voltage difference obtained by subtracting the open circuit voltage of the second battery from the open circuit voltage of the first battery is equal to or higher than a predetermined voltage difference when the parallel charging is started by turning on the upper arm of the inverter, the inverter is switched to lower the charging power to charge the second battery.

### CROSS-REFERENCE TO RELATED APPLICATION

This application claims priority to Japanese Patent Application No. 2024-016775 filed on Feb. 7, 2024, incorporated herein by reference in its entirety.

### BACKGROUND

### 1. Technical Field

The present disclosure relates to a power supply system, and in more detail, relates to a power supply system that includes two batteries capable of charging and discharging by a series connection and charging and discharging by a parallel connection.

### 2. Description of Related Art

As a power supply system of this type, a power supply system that has two batteries capable of charging and discharging by a series connection and charging and discharging by a parallel connection has been proposed (see, for example, Japanese Unexamined Patent Application Publication No. 2019-080474 (JP 2019-080474 A)). In the system, charging or discharging of each of the batteries is performed so a voltage difference of the two batteries becomes equal to or less than a predetermined threshold. As a result, equilibrium of the voltages of the two batteries is performed.

### SUMMARY

However, in the power supply system, when a difference in the voltages of the two batteries is opened for some reason, and charging of the two batteries is attempted by connecting the two batteries in parallel, a case may occur in which an excessive current flows from the battery with a high voltage to the battery with a low voltage.

A main objective of the present disclosure is a power supply system that suppresses an excessive current from flowing when two batteries capable of charging and discharging by a series connection and charging and discharging by a parallel connection are charged by the parallel connection.

The power supply system of the present disclosure adopts the following techniques in order to achieve the main objective.

The power supply system of the present disclosure includes
a first battery,
a second battery,
a series connection line that connects a negative electrode terminal of the first battery and a positive electrode terminal of the second battery,
a series connection relay attached to the series connection line,
a positive electrode bus connected to a positive electrode terminal of the first battery,
a negative electrode bus connected to a negative electrode terminal of the second battery,
an inverter connected to the positive electrode bus and the negative electrode bus, a three-phase AC motor driven by the inverter,
a positive electrode side relay attached to the positive electrode bus, a negative electrode side relay attached to the negative electrode bus,
a first parallel connection line that connects the first battery side and the negative electrode bus by the series connection relay of the series connection line,
a first parallel connection relay attached to the first parallel connection line,
a second parallel connection line that connects the positive electrode terminal of the second battery and a neutral point of the three-phase AC motor,
a second parallel connection relay attached in order from the second battery side to the second parallel connection line,
a DC charging connector connected closer to the inverter side than the positive electrode side relay of the positive electrode bus and closer to the inverter side than the negative electrode side relay of the negative electrode bus via a power line that has a charging relay, and a control device that controls each of the relays and the inverter. When the control device starts parallel charging of the first battery and the second battery in a state in which the positive electrode side relay, the negative electrode side relay, the first parallel connection relay, and the second parallel connection relay are turned ON and the series connection relay is turned OFF, the control device charges the second battery by switching the inverter and stepping down a charging power when a voltage difference obtained by subtracting a voltage of the second battery from a voltage of the first battery is equal to or more than a predetermined voltage difference.

In the power supply system of the present disclosure, when the control device starts parallel charging of the first battery and the second battery in a state in which the positive electrode side relay, the negative electrode side relay, the first parallel connection relay, and the second parallel connection relay are turned ON and the series connection relay is turned OFF, the control device charges the second battery by switching the inverter and stepping down a charging power when a voltage difference obtained by subtracting a voltage of the second battery from a voltage of the first battery is equal to or more than a predetermined voltage difference. As a result, the voltage difference is reduced, and an excessive current due to the voltage difference being large when the first battery and the second battery are connected in parallel can be suppressed from flowing.

In the power supply system of the present disclosure, the control device may start parallel charging of the first battery and the second battery by turning ON an upper arm of the inverter when the voltage difference is less than the predetermined voltage difference.

In the power supply system of the present disclosure, when the voltage difference is a negative value, namely, when the voltage of the first battery is lower than the voltage of the second battery, the control device charges only the first battery by turning OFF the upper arm of the inverter. When the control device estimates that the voltage of the first battery is equal to or more than the voltage of the second battery, the control device may start parallel charging of the first battery and the second battery by turning ON the upper arm of the inverter. In this case, when the voltage of the first battery is equal to or more than the voltage of the second battery and the voltage difference is less than the predetermined voltage difference, the control device can start parallel charging of the first battery and the second battery by turning ON the upper arm of the inverter. In this case, when only the first battery is charged, and when the voltage of the first battery is equal to or more than the voltage of the second battery in a state in which a charging current of the first battery is limited, the control device may estimate that an open voltage of the first battery is equal to or more than an open voltage of the second battery. This is based on the fact that the voltage of the first battery in a state in which a charging current of the first battery is limited is very close to the open voltage of the first battery.

In the power supply system of the present disclosure, when the voltage of the first battery becomes lower than the voltage of the second battery during parallel charging of the first battery and the second battery, the control device charges only the first battery by turning OFF the upper arm of the inverter. Also, afterwards, when the control device estimates that the voltage of the first battery is equal to or more than the voltage of the second battery, the control device may charge the first battery and the second battery in parallel by turning ON the upper arm of the inverter. As a result, the first battery and the second battery can be charged in parallel while securing a state in which the voltage of the first battery is equal to or more than the voltage of the second battery.

In the power supply system of the present disclosure, the control device may notify deterioration learning of the battery when a current that charges the first battery by the second battery flows when parallel charging is completed in a state in which the open voltage of the first battery is higher than the open voltage of the second battery by a relationship map between a storage state and the open voltage of the battery. As a result, the relationship map between the storage state and the open voltage of the battery can be corrected.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a configuration diagram schematically showing a configuration of a power supply system according to an embodiment of the present disclosure;

FIG. 2 is a table showing the states of the relays in various states of the power supply system;

FIG. 3 is an explanatory diagram illustrating a current flow when a first battery and a second battery are connected in parallel and charged by DC power from a DC charging station;

FIG. 4 is a flow chart illustrating an exemplary first half of a parallel charge process; and

FIG. 5 is a flowchart illustrating an example of a second half of the parallel charging process.

### DETAILED DESCRIPTION OF EMBODIMENTS

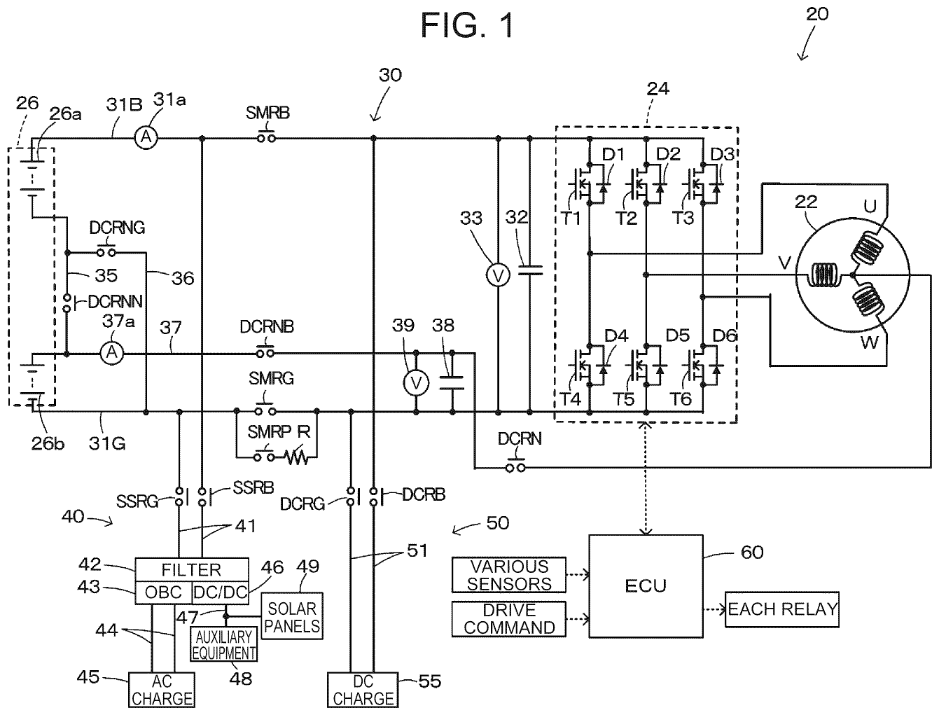

Next, a mode (embodiment) for carrying out the present disclosure will be described. FIG. 1 is a configuration diagram schematically showing a configuration of a power supply system 20 according to an embodiment of the present disclosure. The power supply system 20 of the embodiment functions as a device that exchanges electric power between the battery 26 and the inverter 24 that drives the motor 22, and also functions as a device that charges and discharges the battery 26 by using the motor 22 and the inverter 24 as necessary. The power supply system 20 includes a battery 26, a motor 22, an inverter 24, a power supply main circuit 30, an AC charging circuit 40, a DC charging circuit 50, and an electronic control unit 60.

The motor 22 is configured as a well-known three-phase AC motor including, for example, a rotor having a permanent magnet attached to an outer surface thereof and a stator in which a three-phase coil is wound. Inverter 24 includes six transistors T1 to T6 as switching elements, and six diodes D1 to D6 connected in parallel from transistor T1 to T6. The transistors T1 to T6 are arranged in pairs of two inverters 24 so as to be source-side and sink-side with respect to the positive electrode bus 31B and the negative electrode bus 31G of the battery 26. In the transistors T1 to T6, three-phase coils (U-phase, V-phase, and W-phase) of the motor 22 are connected to respective connecting points of the pair of transistors. Inverter 24 forms a rotating magnetic field in the three-phase coil by controlling the ratio of the on-time of T6 from the pair of transistors T1 while a voltage is applied between the positive electrode bus 31B and the negative electrode bus 31G, and drives motor 22 to rotate. A first capacitor 32 for smoothing is attached between the positive electrode bus 31B and the negative electrode bus 31G.

The battery 26 includes a first battery 26a and a second battery 26b configured similarly to the first battery 26a. The first battery 26a and the second battery 26b are configured as, for example, a lithium-ion secondary battery or a nickel-hydrogen secondary battery. The positive electrode terminal of the first battery 26a is connected to the positive electrode bus 31B, and the negative electrode terminal of the second battery 26b is connected to the negative electrode bus 31G. The negative electrode terminal of the first battery 26a is connected to the positive electrode terminal of the second battery 26b by a series power line 35 to which a relay DCRNN included in the configuration of the power supply main circuit 30 is attached. Therefore, when the relay DCRNN is turned on, the first battery 26a and the second battery 26b function as one battery connected in series.

The power supply main circuit 30 includes a positive electrode bus 31B, a negative electrode bus 31G, and a series power line 35. The power supply main circuit 30 further includes a first parallel power line 36 that connects the negative electrode terminal of the first battery 26a and the negative electrode bus 31G, and a second parallel power line 37 that connects the positive electrode terminal of the second battery 26b to the neutral point of the motor 22. A positive electrode side relay SMRB is attached to the positive electrode bus 31B, and a negative electrode side relay SMRG is attached to the negative electrode bus 31G. In addition, the negative electrode bus 31G is provided with a precharge circuit including a precharge relay SMRP and a resistor R in parallel with the negative electrode side relay SMRG. The positive electrode side relay SMRB, the negative electrode side relay SMRG, and the precharge circuit constitute a system main relay. That is, when the first battery 26a and the second battery 26b are connected in series, the positive electrode side relay SMRB is turned on and the precharge relay SMRP is turned on to charge the first capacitor 32. When the charging of the first capacitor 32 is completed, the negative electrode side relay SMRG is turned on and the precharge relay SMP is turned off. As a result, electric power from the battery 26 including the first battery 26a and the second battery 26b connected in series can be supplied to the inverter 24, and conversely, the battery 26 can be charged by regenerative electric power from the motor 22.

A relay DCRNG is attached to the first parallel power line 36. A relay DCRNB is attached to the second battery 26b side and a relay DCRN is attached to the neutral point side of the motor 22 to the second parallel power line 37. A second capacitor 38 is attached between the relay DCRNB and the relay DCRN of the second parallel power line 37 and to the negative electrode bus 31G.

The AC charging circuit 40 includes an AC charging power line 41 connected to the positive electrode bus 31B and the negative electrode bus 31G, a On Board Charger (OBC) 43 connected to the AC charging power line 41 via the filter 42, and a AC charging connector 45 connected to On Board Charger 43 by the power line 44. Further, the AC charging circuit 40 includes a DC/DC converter 46 connected in parallel with On Board Charger 43 to the AC charging power line 41 via the filter 42, and an auxiliary machine 48 and a solar panel 49 connected to DC/DC converter 46 by the power line 47. A relay SSRB is attached to the positive line of the AC charging power line 41, and a relay SSRG is attached to the negative line.

The DC charging circuit 50 includes a DC charging power line 51 connected to the positive electrode bus 31B and the negative electrode bus 31G, and a DC charging connector 55 connected to the DC charging power line 51. A relay DCRB is attached to the positive line of the DC charging power line 51, and a relay DCRG is attached to the negative line.

The electronic control unit 60 is configured as a microcomputer centered on a CPU (not shown). Signals from various sensors are input to the electronic control unit 60. Examples of the various sensors include a voltage sensor 33 that detects a voltage VH between terminals of the first capacitor 32 and a voltage sensor 39 that detects a voltage VD between terminals of the second capacitor 38. Examples of the various sensors include a current sensor 31a for detecting a current Ib1 flowing in the first battery 26a, a current sensor 37a for detecting a current Id flowing in the second parallel power line 37, and a phase current sensor (not shown) for detecting a phase current Iu, Iv, Iw flowing in three phases of the motor 22. As other examples of the various sensors, a voltage sensor (not shown) that detects a voltage Vb1 between terminals of the first battery 26a, a voltage sensor (not shown) that detects a voltage Vb2 between terminals of the second battery 26b, and the like can be cited. Since the electronic control unit 60 also functions as a control device for driving the motor 22, it also inputs a drive command and the like. When the power supply system 20 is mounted on a vehicle and the motor 22 is used as a motor for traveling, an accelerator operation amount and a vehicle speed may be input to the electronic control unit 60, and a torque command for the motor 22 may be generated by the electronic control unit 60.

The electronic control unit 60 outputs a drive control signal to each relay, a switching control signal to the inverter 24, and the like. The relays can include positive electrode side relay SMRB or negative electrode side relay SMRG, relay SMRP for precharge, relay DCRNN, relay DCRNG, relay DCRNB, relay DCRN, relay SSRB, relay SSRB, relay DCRB, relay DCRG, etc.

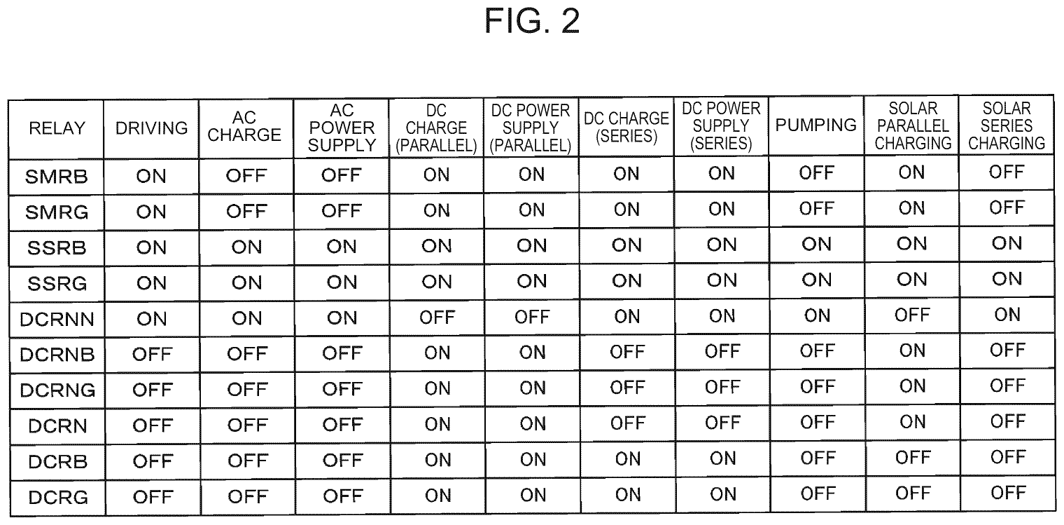

FIG. 2 is a table showing the states of the relays in various states of the power supply system 20.
(1) In order to drive the motor 22 as a driving motor, the positive electrode side relay SMRB, the negative electrode side relay SMRG, the relay SSRB, the relay SSRG, and the relay DCRNN are turned on. In addition, the relay DCRB, relay DCRG, relay DCRN, relay DCRB, and relay DCRG are turned off.
(2) When connecting the connecter from AC charging stand to AC charging connector 45, charging the battery 26 by the alternating power from AC charging stand, connecting the external electric load to AC charging connector 45, and charging the power from the battery 26 to the external electric load as the alternating power, the state is the state in which the relays SSRB and the relays SSRG, relays DCRNN are on, and the state in which the positive electrode side relay SMRB or negative electrode side relay SMRG, DCRB relays, relays DCRG, relays DCRN, relays DCRB, and relays DCRG are off.
(3) When connecting the connection connector from DC charging stand to DC charging connector 55, plugging the first battery 26a and the second battery 26b in parallel by the direct current power from DC charging stand, connects the external electric load to DC charging connector 55, and power from the battery 26 as direct current power in a state where the first battery 26a and the second battery 26b are connected in parallel, the positive electrode side relay SMRB, negative electrode side relay SMRG, relay SSRB, relay SSRG, relay DCRB, relay DCRG, relay DCRN, relay DCRB, and relay DCRG are on, and the relays DCRNN is off.
(4) When connecting the connector from DC charging stand to DC charging connector 55 and charging the first battery 26a and the second battery 26b in series with the DC power from DC charging stand, or when connecting the external electrical load to DC charging connector 55 and connecting the first battery 26a and the second battery 26b in series with the external electrical load from the battery 26, the positive electrode side relay SMRB, negative electrode side relay SMRG, relay SSRB, relay SSRG, relay DCRNN, relay DCRB, and relay DCRG are turned on, and the relay DCRNB, relay DCRNG, and relay DCRN are turned off.
(5) When power is supplied to the auxiliary machine 48 such as a drive recorder during parking, the relay SSRB, the relay SSRG, and the relay DCRNN are turned on. Furthermore, the positive electrode side relay SMRB, negative electrode side relay SMRG, relays DCRNB, relays DCRNG, relays DCRN, relays DCRB, and relays DCRG are turned off.
(6) When charging by connecting the first battery 26a and the second battery 26b in parallel using the power generated by the solar panel 49, the positive electrode side relay SMRB, negative electrode side relay SMRG, relays SSRB, relays SSRG, relays DCRNB, relays DCRNG, and relays DCRN shall be on. Further, the relay DCRNN, the relay DCRB, and the relay DCRG are turned off.
(7) When the first battery 26a and the second battery 26b are connected in series and charged using the generated electric power of the solar panel 49, the relay SSRB, the relay SSRG, and the relay DCRNN are turned on. Furthermore, the positive electrode side relay SMRB, negative electrode side relay SMRG, relays DCRNB, relays DCRNG, relays DCRN, relays DCRB, and relays DCRG are turned off.

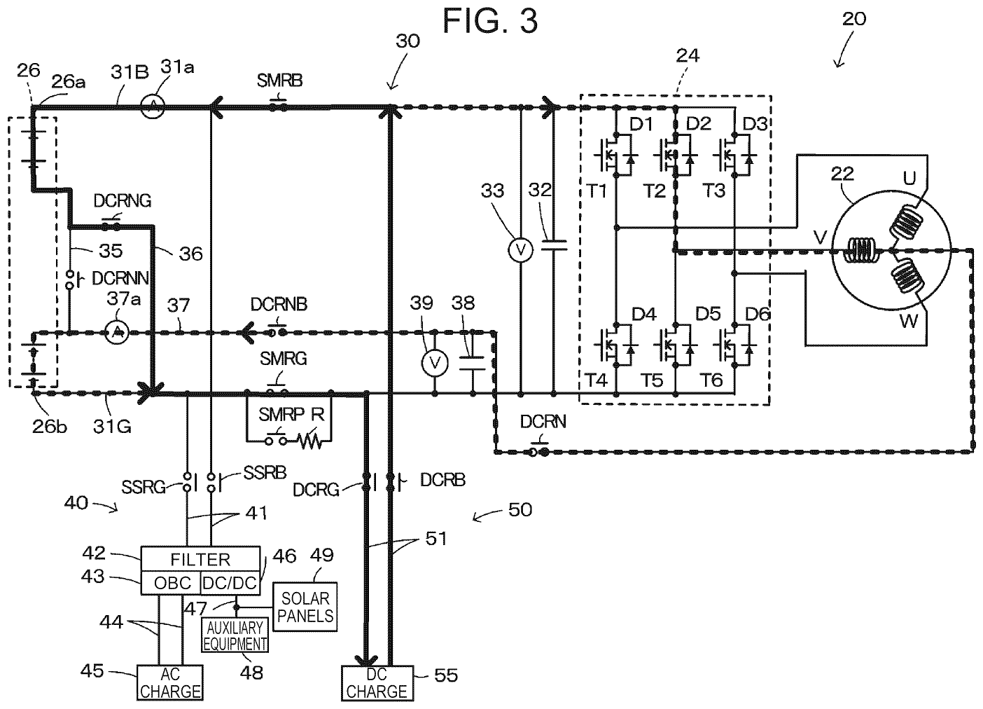

Next, an operation of the power supply system 20 of the embodiment configured in this way, in particular, an operation when the connecting connector from DC charging station is connected to DC charging connector 55 and the first battery 26a and the second battery 26b are connected in parallel by the DC power from DC charging station will be described. FIG. 3 is an explanatory diagram illustrating a current flow when the first battery 26a and the second battery 26b are connected in parallel and charged by DC power from DC charging station. In the drawing, a thick solid line with an arrow indicates a charging current of the first battery 26a, and a thick broken line with an arrow indicates a charging current of the second battery 26b. Incidentally, connects the connection connector from DC charging stand to DC charging connector 55, when charging by connecting the first battery 26a and the second battery 26b in parallel by the direct current power from DC charging stand, as described above, the positive electrode side relay SMRB, negative electrode side relay SMRG, relay SSRB, relay SSRG, relay DCRB, relays DCRG, relay DCRN, relay DCRB, and relay DCRG are turned on, and also the relay DCRNN is turned off. Then, the upper arm of the inverter 24 is turned on. The first battery 26a, as shown in a thick solid line with arrows in FIG. 3, from the positive side line of the DC charging power line 51 connected to DC charging connector 55 positive electrode bus 31B positive electrode side relay SMRB, the first battery 26a, the relay DCRNG of the first parallel power line 36, the negative electrode side relay SMRG of the negative electrode bus 31G, is charged by the charging current flowing in the order of the negative electrode side line of the DC charging power line 51. The second battery 26b is charged by the charge current flowing in the order of the upper arm of the inverter 24 from the positive electrode side line of the DC charging power line 51 connected to DC charging connector 55 via the positive electrode bus 31B, the neutral point of the motor 22, the relay DCRN and the relay DCRNB of the second parallel power line 37, the second battery 26b, the negative electrode side relay SMRG of the negative electrode bus 31G, and the negative electrode side line of the DC charging power line 51, as shown by the thick broken line of FIG. 3.

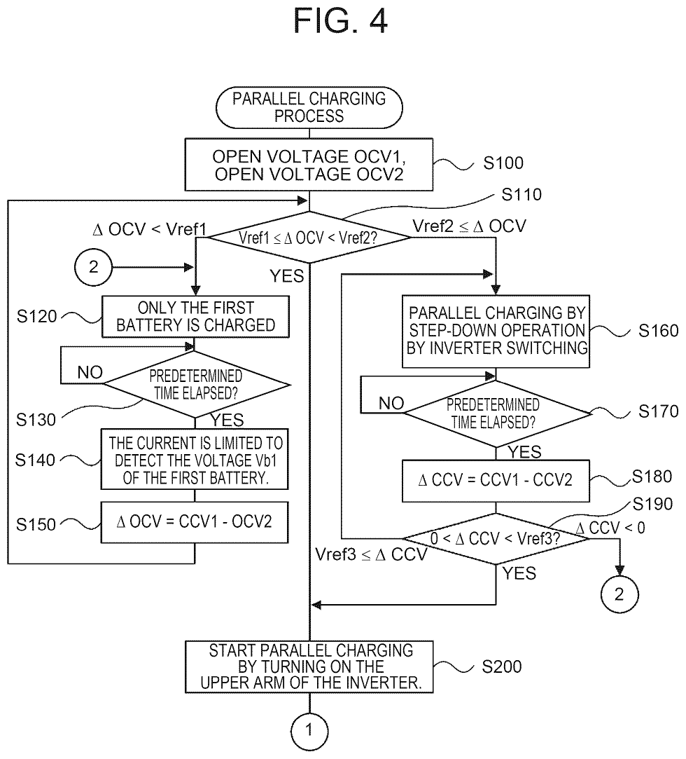

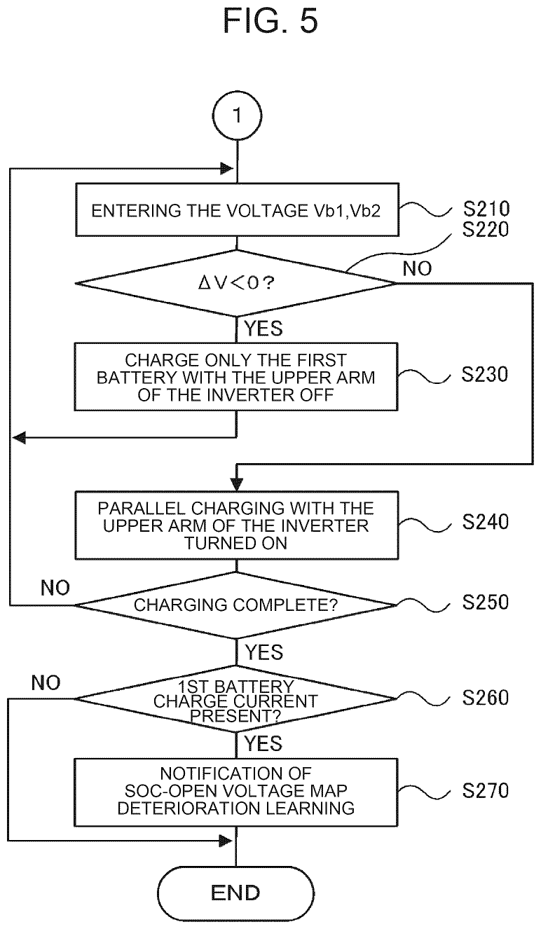

In the power supply system 20 of the embodiment, parallel charging is performed by the parallel charging process illustrated in FIG. 4 and FIG. 5. When the parallel charge process is executed, the electronic control unit 60 first receives the open circuit voltage OCV1 of the first battery 26a and the open circuit voltage OCV2 of the second battery 26b (S100). Then, it is determined whether or not the open-circuit voltage difference ΔOCV (ΔOCV=OCV1−OCV2) obtained by subtracting the open-circuit voltage OCV2 from the open-circuit voltage OCV1 is greater than or equal to the threshold Vref1 and less than the threshold Vref2 (S110). The open-circuit voltage OCV1 of the first battery 26a and the open-circuit voltage OCV2 of the second battery 26b may be derived by applying the power storage ratio SOC to a map indicating the relation between the power storage ratio SOC and the open-circuit voltage OCV of the respective batteries. The threshold Vref1 is a predetermined value such that the open circuit voltage OCV1 of the first battery 26a is equal to or higher than the open circuit voltage OCV2 of the second battery 26b even if there is a measurement error of the open circuit voltage OCV1 of the first battery 26a or the open circuit voltage OCV2 of the second battery 26b. The threshold Vref2 is an allowable voltage difference between the open circuit voltage OCV1 of the first battery 26a and the open circuit voltage OCV2 of the second battery 26b, and is larger than the threshold Vref1.

When it is determined in S110 that the open-circuit voltage difference ΔOCV (ΔOCV=OCV1−OCV2) is greater than or equal to the threshold Vref1 and less than the threshold Vref2, the upper arm of the inverter 24 is turned on and parallel charging is started (S200). In parallel charging, as described with reference to FIG. 3, the charging circuit of the second battery 26b includes three-phase coils of the motor 22. Therefore, the impedance in the charging circuit of the second battery 26b is larger than the impedance in the charging circuit of the first battery 26a. Therefore, the charging current of the first battery 26a is slightly larger than the charging current of the second battery 26b, and the voltage Vb1 of the first battery 26a is maintained slightly larger than the voltage Vb2 of the second battery 26b. In this way, the voltage Vb1 of the first battery 26a is set to be slightly larger than the voltage Vb2 of the second battery 26b in order to prevent the current for charging the first battery 26a from flowing due to the fact that the voltage Vb2 of the second battery 26b is larger than the voltage Vb1 of the first battery 26a when the parallel charging is completed, by the second battery 26b.

When it is determined in S110 that the open-circuit voltage difference ΔOCV (ΔOCV=OCV1−OCV2) is less than the threshold Vref1, only the first battery 26a is charged until a predetermined period of time elapses (S120, S130). When the open-circuit voltage difference ΔOCV is less than the threshold Vref1, only the first battery 26a is charged in order to prevent the current for charging the first battery 26a from flowing by the second battery 26b when the parallel charging is started when the open-circuit voltage difference ΔOCV becomes negative. The predetermined time period is a relatively short time period, and may be, for example, 1 second, 2 seconds, 5 seconds, or 10 seconds. When only the first battery 26a is charged until the predetermined period elapses, the charging current of the first battery 26a is limited and the voltage Vb1 (CCV1) of the first battery 26a is detected (S140). Then, the detected voltage Vb1 (CCV1) is regarded as the open circuit voltage OCV1 of the first battery 26a, and the open circuit voltage difference ΔOCV is calculated (S150). Then, the process returns to the process of determining whether or not the open-circuit voltage difference ΔOCV of S110 is equal to or greater than the threshold Vref1 and less than the threshold Vref2. As a result, the charge of only the first battery 26a is continued until the open-circuit voltage difference ΔOCV becomes equal to or larger than the threshold Vref1.

When it is determined in S110 that the open-circuit voltage difference ΔOCV (ΔOCV=OCV1−OCV2) is equal to or greater than the threshold Vref2, the upper arm of the inverter 24 is switched until a predetermined period of time elapses, and parallel charging is performed with the step-down operation of the external charging power (S160, S170). After a predetermined period of time, the voltage difference ΔCCV (ΔCCV=CCV1−CCV2) is calculated (S180) using the voltage Vb1 (CCV1) of the first battery 26a and the voltage Vb2 (CCV2) of the second battery 26b. Then, it is determined whether or not the voltage difference ΔCCV is greater than 0 and less than the threshold Vref3 (S190). The threshold Vref3 may be the same value as the threshold Vref2 or a value slightly smaller than the threshold Vref2. When it is determined that the voltage difference ΔCCV is greater than 0 and less than the threshold Vref3, the upper arm of the inverter 24 is turned on and parallel charging is started (S200).

When it is determined in S190 that the voltage difference ΔCCV is equal to or larger than the threshold Vref3, the upper arm of the inverter 24 is switched until a predetermined time elapses, and S160, S170 returns to the parallel charging operation accompanied by the step-down operation of the external charging power. As a result, the voltage difference ΔCCV switches the upper arm of the inverter 24 until the voltage difference ΔCCV reaches less than the threshold Vref3, and the parallel charging with the step-down operation of the external charging power is continued.

When it is determined in S190 that the voltage difference ΔCCV is equal to or less than the value 0, the process of charging only the first battery 26a for a predetermined period of S120, S130 is performed.

When the parallel charging is started, a process of maintaining the voltage Vb1 of the first battery 26a slightly larger than the voltage Vb2 of the second battery 26b is performed (S240 from S210) until the determination of completion of the parallel charging is performed (S250). In this process, first, the voltage Vb1 of the first battery 26a and the voltage Vb2 of the second battery are inputted (S210), and it is determined whether or not the voltage difference ΔV (ΔV=Vb1−Vb2) obtained by subtracting the voltage Vb2 from the voltage Vb1 is negative (S220). When it is determined that the voltage difference ΔV is a negative value, the upper arm of the inverter 24 is turned off and only the first battery 26a is charged (S230), and the process returns to the process of inputting the voltage Vb1 of the first battery 26a of S210 and the voltage Vb2 of the second battery. That is, only the first battery 26a is charged until the voltage difference ΔV reaches the value 0 or more. When it is determined in S220 that the voltage difference ΔV is equal to or greater than 0, the upper arm of the inverter 24 is turned on, and parallel charging is performed (S240), and the end determination of parallel charging is performed (S250). When it cannot be determined that the parallel charge is ended, the process returns to the process of inputting the voltage Vb1 of the first battery 26a and the voltage Vb2 of the second battery of S210. The end of the parallel charging is determined when the battery 26 is fully charged, when a predetermined charging time has elapsed, when the power storage ratio SOC of the battery 26 reaches a predetermined condition as the end of charging, when the user instructs the end of charging, or the like. As described above, the voltage Vb1 of the first battery 26a is maintained slightly larger than the voltage Vb2 of the second battery 26b in order to prevent the current for charging the first battery 26a by the second battery 26b from flowing due to the voltage Vb2 of the second battery 26b becoming larger than the voltage of the first battery 26a when the parallel charging is completed.

When the end of the parallel charging is determined and the charging is ended, it is determined whether or not the charging current flows through the first battery 26a (S260). When it is determined that the charge current flows in the first battery 26a, a notification indicating that the map of the power storage ratio SOC and the open-circuit voltage OCV needs to be deterioration learning is given (S270), and the process ends. On the other hand, when it is determined that the charge current does not flow in the first battery 26a, it is determined that the map is not deteriorated, and the process ends.

In the power supply system 20 of the above-described embodiment, when the first battery 26a and the second battery 26b are connected in parallel to each other and parallel charging is started, the following process is performed. When the open-circuit voltage difference ΔOCV obtained by subtracting the open-circuit voltage OCV2 of the second battery 26b from the open-circuit voltage OCV1 of the first battery 26a is equal to or greater than the threshold Vref2, the upper arm of the inverter 24 is switched until the open-circuit voltage difference ΔOCV reaches less than the threshold Vref3, and parallel charging is performed with the step-down operation of the external charging power. Accordingly, it is possible to suppress an excessive current that flows through the circuit due to the large open voltage difference ΔOCV when the parallel charging is started with the upper arm of the inverter 24 turned on. Further, when the open voltage difference ΔOCV is less than the threshold Vref1, only the first battery 26a is charged until the open voltage difference ΔOCV reaches the threshold Vref1 or more. Accordingly, it is possible to prevent a current for charging the first battery 26a from flowing by the second battery 26b when the parallel charging is started. At this time, only the first battery 26a is charged until the open circuit voltage difference ΔOCV becomes equal to or greater than 0 by calculating the open circuit voltage difference ΔOCV assuming that the voltage Vb1 of the first battery 26a detected by limiting the charge current of the first battery 26a is the open circuit voltage OCV1 of the first battery 26a. Therefore, the open circuit voltage difference ΔOCV of the true value can be more reliably set to the value 0 or more.

In the power supply system 20 of the embodiment, only the first battery 26a is charged with the upper arm of the inverter 24 turned off until the voltage difference ΔV becomes equal to or greater than the value 0 when the voltage difference ΔV obtained by subtracting the voltage Vb1 of the first battery 26a from the voltage Vb2 of the second battery 26b becomes a negative value during parallel charging. When the voltage difference ΔV reaches the value 0 or more, the upper arm of the inverter 24 is turned on and parallel charging is executed. This makes it possible to maintain the voltage Vb1 of the first battery 26a slightly larger than the voltage Vb2 of the second battery 26b. Therefore, the second battery 26b can prevent the current for charging the first battery 26a from flowing due to the voltage Vb2 of the second battery 26b being larger than the voltage of the first battery 26a when the parallel charging is completed.

In the power supply system 20 according to the embodiment, when the parallel charging is ended, when it is detected that the charging current flows through the first battery 26a, it is notified that the map of the power storage ratio SOC and the open-circuit voltage OCV needs to be deterioration learning. Accordingly, it is possible to notify that the map of the power storage ratio SOC and the open-circuit-voltage OCV needs to be deterioration learning.

Although the present disclosure has been described above using the embodiment, the present disclosure is not limited to the embodiment in any way, and may be implemented in various modes without departing from the scope of the present disclosure.

The present disclosure is applicable to a manufacturing industry of a power supply system and the like.

What is claimed is:

1. A power supply system comprising:
a first battery;
a second battery;
a series connection line that connects a negative electrode terminal of the first battery and a positive electrode terminal of the second battery;
a series connection relay attached to the series connection line;
a positive electrode bus connected to a positive electrode terminal of the first battery;
a negative electrode bus connected to a negative electrode terminal of the second battery;
an inverter connected to the positive electrode bus and the negative electrode bus;
a three-phase AC motor driven by the inverter;
a positive electrode side relay attached to the positive electrode bus;
a negative electrode side relay attached to the negative electrode bus;
a first parallel connection line that connects the first battery side and the negative electrode bus by the series connection relay of the series connection line;
a first parallel connection relay attached to the first parallel connection line;
a second parallel connection line that connects the positive electrode terminal of the second battery and a neutral point of the three-phase AC motor;
a second parallel connection relay attached in order from the second battery side to the second parallel connection line;
a DC charging connector connected closer to the inverter side than the positive electrode side relay of the positive electrode bus and closer to the inverter side than the negative electrode side relay of the negative electrode bus via a power line that has a charging relay; and
a control device that controls each of the relays and the inverter, wherein
when the control device starts parallel charging of the first battery and the second battery in a state in which the positive electrode side relay, the negative electrode side relay, the first parallel connection relay, and the second parallel connection relay are turned ON and the series connection relay is turned OFF, the control device charges the second battery by switching the inverter and stepping down a charging power when a voltage difference obtained by subtracting a voltage of the second battery from a voltage of the first battery is equal to or more than a predetermined voltage difference.

2. The power supply system according to claim 1, wherein the control device starts parallel charging of the first battery and the second battery by turning an upper arm of the inverter ON when the voltage difference is less than the predetermined voltage difference.
